(19) United States
(12) Patent Application Publication
(10) Pub. No.: US 2013/0136838 A1
(43) Pub. Date: May 30, 2013

(54) SWEETENER BLEND COMPOSITIONS

(71) Applicants: Rafael I. San Miguel, Atlanta, GA (US); Indra Prakash, Alpharetta, GA (US)

(72) Inventors: Rafael I. San Miguel, Atlanta, GA (US); Indra Prakash, Alpharetta, GA (US)

(21) Appl. No.: 13/606,976

(22) Filed: Sep. 7, 2012

Related U.S. Application Data
(60) Provisional application No. 61/532,885, filed on Sep. 9, 2011.

(51) Int. Cl. A23L 1/236; A23L 2/60

(52) U.S. Cl. CPC A23L 1/2363; A23L 2/60
USPC 426/548; 426/658; 426/590

(57) ABSTRACT

Natural sweetener blends and sweetened compositions having an improved, sugar-like taste quality are provided herein. Also provided are methods of improving the sugar-like taste quality of sweetened compositions comprising such natural sweetener blends.

### CROSS REFERENCE TO RELATED APPLICATIONS

This application claims the benefit of U.S. Provisional Application No. 61/532,885 filed Sep. 9, 2011, which is incorporated herein by reference in its entirety.

### FIELD OF THE INVENTION

The invention generally relates to low or non-caloric, natural sweetener and sweetened compositions having an improved, sugar-like taste quality. The present invention also includes methods of improving the sugar-like taste quality of sweetened compositions comprising such sweeteners.

### BACKGROUND

Carbohydrate sweeteners (e.g., sucrose) have traditionally been used to sweeten foods and beverages. While the taste of carbohydrate sweeteners is familiar and desirable to many consumers, the caloric content of carbohydrate sweeteners is less desirable. Increasingly health-conscious consumers have generated demand for low or no-calorie alternatives to carbohydrate sugars, including saccharin, aspartame, acesulfame-K, cyclamate, neotame and sucralose. While these carbohydrate alternatives remain popular with consumers, there is increasing demand for natural low or non-caloric sweeteners.

Recently, sweeteners such as Stevia and Lo Han Guo have garnered much attention as both non-caloric and natural. Stevia sweeteners are derived (e.g., extracted) from Stevia rebaudiana (Bertoni), a perennial shrub of the Asteracae (Compositae) family native to Brazil and Paraguay. The major constituents in the leaves of S. rebaudiana are diterpenoid glycosides of the steviol ent-13-hydroxykaur-16-en-19-oic acid. While some steviol glycosides are sweet, others have intense bitter characteristics, licorice tastes and prolonged aftertastes. Stevioside and rebaudioside A are some of the sweetest and most abundant steviol glycosides that can be obtained from the Stevia plant.

Depending on the methods of extraction, the purity of the Stevia extract varies. Some Stevia sweeteners contain a mixture of steviol glycosides. Stevia sweeteners that contain a mixture of steviol glycosides often present taste properties that are objectionable to the consumer. Other Stevia sweeteners contain primarily one steviol glycoside in very high purity. Methods of obtaining stevioside and rebaudioside A in purities of 95% or greater are known (U.S. Patent Publication No. 2008/02922764 and U.S. Patent Publication No. 20070292582, both to Prakash, et al.).

Although rebaudioside A and stevioside are known to be among the sweetest steviol glycosides, these compounds actually exhibit unpleasant off-notes (e.g., bitter tastes, licorice tastes, sweetness linger and strong aftertastes) when used in the concentrations necessary to obtain 10% sucrose equivalence, a common metric used to measure the flavor and temporal profile of a sweetener.

Lo Han Guo, sometimes spelled Lo Han Kuo, is the common name for the Chinese fruit Momordica grosvenorii (Swingle), also called Siraitia grosvenorii, belonging to the Cucurbitaceae family. Siraitia grosvenorii is an herbaceous perennial vine native to southern China, and its Lo Han Guo fruit is well known for its sweet taste. The fruit extract is around 150-300 times sweeter than sugar, and has been used as a natural sweetener in China for nearly a millennium. However, Lo Han Guo has a slower sweetness onset compared to sucrose and a strong sweet lingering aftertaste.

Accordingly, it is desirable to enhance, or increase, the overall perception of the sugar-like taste quality of rebaudioside A and stevioside such that sweetener composition exhibits a taste more like that of sugar. There is a need for new and improved sweetener compositions containing rebaudioside A and/or stevioside sweeteners, and sweetened compositions comprising such compounds, with improved sugar-like taste quality. Furthermore, there is a need for methods of improving the sugar-like taste quality and sugar-like sweet temporal profiles and characteristics of sweetener and sweetened compositions comprising rebaudioside A and/or stevioside sweeteners.

### SUMMARY OF THE INVENTION

Natural, low or non-caloric sweetener compositions and sweetened compositions with improved sugar-like taste quality are provided herein containing either (i) a blend of steviol glycosides or (ii) a blend of mogrosides and steviol glycosides. In one embodiment, the sugar-like taste quality of the compositions is improved by blending, at certain concentrations, a first composition containing certain steviol glycosides with a second composition containing certain other steviol glycosides. In another embodiment, the sugar-like taste quality of the compositions is improved by blending, at certain concentrations, a first composition containing certain mogrosides with a second composition containing certain steviol glycosides. The blend of the first and second compositions (collectively referred to herein as the “natural sweetener blend”) exhibits increased sugar-like taste quality compared to either composition alone, as can be determined by comparing the flavor profile and/or temporal profile of either the first or second composition of the natural sweetener blend to the natural sweetener blend itself.

In one embodiment, a natural sweetener blend comprises:
(1) a first composition comprising at least one first compound selected from the group consisting of mogroside IV, mogroside V, mogroside VI, isomogroside V, 11-oxomogroside, rebaudioside A, stevioside and combinations thereof,
   wherein the at least one first compound is present in an amount of at least about 95% by weight of the first composition; and
(2) a second composition comprising at least one second compound selected from the group consisting of steviolmonoside, steviolbioside, rebaudioside B and combinations thereof,
   wherein the at least one second compound is present in an amount of at least about 95% by weight of the second composition; and
   wherein the weight ratio of the first composition to the second composition is from about 99:1 to about 75:25.

In some embodiments, the first compound is mogroside IV. In other embodiments, the first compound is mogroside V. In yet other embodiments, the first compound is mogroside VI. In other embodiments, the first compound is isomogroside V. In other embodiments, the first compound is 11-oxomogroide. In other embodiments, the first compound is rebaudioside A. In other embodiments, the first compound is stevioside.

In some embodiments, the first compound is rebaudioside A. In other embodiments, the first compound is stevioside.

In one embodiment, rebaudioside A comprises at least about 97% by weight of the first composition. In another embodiment, rebaudioside A comprises about 100% by weight of the first composition.

In one embodiment, stevioside comprises at least about 97% by weight of the first composition. In another embodiment, stevioside comprises about 100% by weight of the first composition.

In some embodiments, the at least one second compound is steviolmonoside. In other embodiments, the at least one second compound is steviolbioside. In yet other embodiments, the at least one second compound is rebaudioside B.

In one embodiment, steviolmonoside comprises at least about 97% by weight of the second composition. In another embodiment, steviolmonoside comprises about 100% by weight of the second composition.

In one embodiment, steviolbioside comprises at least about 97% by weight of the second composition. In another embodiment, steviolbioside comprises about 100% by weight of the second composition.

In one embodiment, rebaudioside B comprises at least about 97% by weight of the second composition. In another embodiment, rebaudioside B comprises about 100% by weight of the second composition.

In preferred embodiments, the weight ratio of the first composition to the second composition is about 92:8, more preferably about 85:15, more preferably about 83:17.

In preferred embodiments, the first compound comprises at least about 97% by weight of the first composition. In other embodiments, the first compound comprises about 100% by weight of the first composition.

In preferred embodiments, the weight ratio of the first composition to the second composition is about 92:8, more preferably about 85:15, more preferably about 83:17.

In one embodiment, the natural sweetener blend comprises:
(1) a first composition comprising at least about 95% rebaudioside A by weight, and
(2) a second composition comprising at least about 95% rebaudioside B by weight,
   wherein the weight ratio of the first composition to the second composition is from about 99:1 to about 75:25.

In another embodiment, a natural sweetener blend comprises:
(1) a first compound selected from the group consisting of rebaudioside A and stevioside; and
(2) a second compound selected from the group consisting of steviolmonoside, steviolbioside and rebaudioside B,
   wherein both the first and second compound are about 100% pure, and
   wherein the weight ratio of the first compound to the second compound is from about 99:1 to about 75:25.

In one embodiment, the weight ratio of the first compound to the second compound is about 92:8, more preferably about 85:15, more preferably about 83:17.

In some embodiments, the natural sweetener blends are incorporated into sweetenable compositions to generate a sweetened composition. In one embodiment, a sweetened composition of the present invention comprises:
(1) a first composition comprising at least one first compound selected from the group consisting of mogroside IV, mogroside V, mogroside VI, isomogroside V, 11-oxomogroside, rebaudioside A, stevioside and combinations thereof,
   wherein the at least one first compound is present in an amount of at least about 95% by weight of the first composition; and
(2) a second composition comprising at least one second compound selected from the group consisting of steviolmonoside, steviolbioside, rebaudioside B and combinations thereof,
   wherein the at least one second compound is present in an amount of at least about 95% by weight of the second composition; and
   wherein the weight ratio of the first composition to the second composition is from about 99:1 to about 75:25.

In some embodiments, the natural sweetener blend is a Stevia sweetener blend wherein both the first and second compositions contain only steviol glycosides. Accordingly, Stevia blends are incorporated into sweetenable compositions to generate a sweetened composition. In one embodiment, a sweetened composition of the present invention comprises:
(1) a first composition comprising at least one first compound selected from the group consisting of rebaudioside A, stevioside and combinations thereof,
   wherein the at least one first compound is present in an amount of at least about 95% by weight of the first composition; and
(2) a second composition comprising at least one second compound selected from the group consisting of steviolmonoside, steviolbioside, rebaudioside B and combinations thereof,
   wherein the at least one second compound is present in an amount of at least about 95% by weight of the second composition; and
   wherein the ratio of the first composition to the second composition is from about 99:1 to about 75:25.

In preferred embodiments, the sweetened composition is a beverage. In more preferred embodiments, the sweetened composition is a reduced-calorie or zero-calorie beverage. Reduced calorie beverages comprise both a natural sweetener blend and at least one caloric sweetener. Zero-calorie beverages comprise a natural sweetener blend and erythritol. Both reduced calorie and zero-calorie beverages may further comprise glucosylated steviol glycosides.

The present invention also includes methods for improving the sugar-like taste quality of a sweetened composition, comprising combining:
(1) a sweetenable composition
(2) a first composition comprising at least one first compound selected from the group consisting of mogroside IV, mogroside V, mogroside VI, isomogroside V, 11-oxomogroside, rebaudioside A, stevioside and combinations thereof,
   wherein the at least one first compound is present in an amount of at least about 95% by weight of the first composition; and
(3) a second composition comprising at least one second compound selected from the group consisting of steviolmonoside, steviolbioside, rebaudioside B and combinations thereof,
   wherein the at least one second compound is present in an amount of at least about 95% by weight of the second composition; and
   wherein the weight ratio of the first composition to the second composition is from about 99:1 to about 75:25.

In preferred embodiments, the natural sweetener blends have improved sugar-like taste quality when compared to either the first composition or the second composition. Sweetened compositions comprising the natural sweetener blends have improved sugar-like taste quality when compared to either sweetened compositions comprising only the first composition or sweetened compositions comprising only the second composition. Natural sweetener blends with improved sugar-like taste quality have a flavor and/or temporal profile similar to that of sugar (sucrose). Accordingly, compared to natural sweeteners such as rebaudioside A or stevioside alone, the natural sweetener blends exhibit decreased sweetness linger (aftertaste), decreased bitterness, decreased astringency, a more sugar-like sweet temporal profile, a more sugar-like taste quality or some combination thereof.

### DETAILED DESCRIPTION

### I. Definitions

The term “sweetener composition,” as generally used herein, is a composition that comprises at least one sweetener.

The term “sugar-like taste quality,” as generally used herein, refers to properties of sweetener and sweetener compositions that closely resemble that of sucrose. Sucrose has a characteristic flavor profile and temporal profile that are known in the art. All sweeteners other than sucrose are generally compared to the baseline taste qualities of sucrose. Compounds, sweetener compositions or sweetened compositions that exhibit sugar-like taste quality have flavor profiles and/or temporal profiles that are similar, comparable, or identical to that of sucrose.

The term “sweetness intensity,” as generally used herein, refers to any perceptible sweetness.

The term “flavor profile,” or “taste profile,” as generally used herein, refers to the intensity of various flavor and/or perceptual attributes of given compound, sweetener composition or sweetened composition. Exemplary flavor attributes are sweetness intensity, bitterness, black licorice, etc. Methods of determining the flavor profile of a given compound or sweetener composition are known in the art.

The term “temporal profile,” as generally used herein, refers to changes in perception of sweetness over time. Every sweetener exhibits a characteristic Appearance Time (AT) and Extinction Time (ET). Most high-potency sweeteners, in contrast to carbohydrate sweeteners, display prolonged ET. The detected sucrose equivalence a given compound or sweetener composition elicits over time. The temporal profile of most sweeteners is neither constant nor similar. Initially, the detected sucrose equivalence spikes to the maximal response level, then tapers off over time. The longer the taper, the greater the detected sweetness linger (i.e. aftertaste) of a compound or sweetener composition.

The term “licorice,” as generally used herein, refers to a sweet and/or aromatic taste of a compound, sweetener composition or sweetened composition.

A. The Natural Sweetener Blends

In one embodiment, the natural sweetener blends described herein comprise:
(1) a first composition comprising at least one first compound selected from the group consisting of mogroside IV, mogroside V, mogroside VI, isomogroside V, 11-oxomogroside, rebaudioside A, stevioside and combinations thereof,
   wherein the at least one first compound is present in an amount of at least 95% by weight of the first composition; and
(2) a second composition comprising at least one second compound selected from the group consisting of steviolmonoside, steviolbioside, rebaudioside B and combinations thereof,
   wherein the at least one second compound is present in an amount of at least 95% by weight of the second composition; and
   wherein the ratio of the first composition to the second composition is from about 99:1 to about 75:25.

In certain embodiments of the present invention, the first composition comprises one or more steviol glycosides selected from the group consisting of rebaudioside A and stevioside, and the second composition comprises one or more steviol glycosides selected from the group consisting of steviolmonocide, steviolbiocide and rebaudioside B. In some embodiments, the mixtures of steviol glycosides in the first and second compositions are different. However, although the mixture of compounds in the first and second compositions are different, a steviol glycoside could be found both the first and second compositions such that the steviol glycoside is a major component (i.e., greater than 50% by weight) of one composition and a minor component (i.e., less than 5% by weight) of the other composition. It is envisaged that, in these scenarios, the relative amounts present as a minor component do not adversely affect the ratio of first composition to second composition.

i. The First Composition

In one embodiment, the first compound is mogroside IV. In a preferred embodiment, mogroside IV comprises at least about 95% by weight of the first composition. In another embodiment, mogroside IV comprises at least about 96% by weight of the first composition. In another embodiment, mogroside IV comprises at least about 97% by weight of the first composition. In yet another embodiment, mogroside IV comprises at least about 98% by weight of the first composition. In still another embodiment, mogroside IV comprises at least about 99% by weight of the first composition. In another embodiment, mogroside IV is about 100% by weight of the first composition.

In another embodiment, the first compound is mogroside V. In a preferred embodiment, mogroside V comprises at least about 95% by weight of the first composition. In another embodiment, mogroside V comprises at least about 96% by weight of the first composition. In another embodiment, mogroside V comprises at least about 97% by weight of the first composition. In yet another embodiment, mogroside V comprises at least about 98% by weight of the first composition. In still another embodiment, mogroside V comprises at least about 99% by weight of the first composition. In another embodiment, mogroside V is about 100% by weight of the first composition.

In another embodiment, the first compound is mogroside VI. In a preferred embodiment, mogroside VI comprises at least about 95% by weight of the first composition. In another embodiment, mogroside VI comprises at least about 96% by weight of the first composition. In another embodiment, mogroside VI comprises at least about 97% by weight of the first composition. In yet another embodiment, mogroside VI comprises at least about 98% by weight of the first composition. In still another embodiment, mogroside VI comprises at least about 99% by weight of the first composition. In another embodiment, mogroside VI is about 100% by weight of the first composition.

In another embodiment, the first compound is isomogroside V. In a preferred embodiment, isomogroside V comprises at least about 95% by weight of the first composition. In another embodiment, isomogroside V comprises at least about 96% by weight of the first composition. In another embodiment, isomogroside V comprises at least about 97% by weight of the first composition. In yet another embodiment, isomogroside V comprises at least about 98% by weight of the first composition. In still another embodiment, isomogroside V comprises at least about 99% by weight of the first composition. In another embodiment, isomogroside V is about 100% by weight of the first composition.

In another embodiment, the first compound is 11-oxomogroside. In a preferred embodiment, 11-oxomogroside comprises at least about 95% by weight of the first composition. In another embodiment, 1′-oxomogroside comprises at least about 96% by weight of the first composition. In another embodiment, 11-oxomogroside comprises at least about 97% by weight of the first composition. In yet another embodiment, 11-oxomogroside comprises at least about 98% by weight of the first composition. In still another embodiment, 1′-oxomogroside comprises at least about 99% by weight of the first composition. In another embodiment, 11-oxomogroside is about 100% by weight of the first composition.

In certain embodiments wherein the natural sweetener blend is a Stevia sweetener blend, the first composition comprises one or more steviol glycosides selected from the group consisting of rebaudioside A, stevioside or a combination thereof. In another embodiment, the first compound is rebaudioside A. In a preferred embodiment, rebaudioside A comprises at least about 95% by weight of the first composition. In another embodiment, rebaudioside A comprises at least about 97% by weight of the first composition. In yet another embodiment, rebaudioside A comprises at least about 98% by weight of the first composition. In still another embodiment, rebaudioside A comprises at least about 99% by weight of the composition. In another embodiment, rebaudioside A is about 100% by weight of the composition.

In another embodiment, the first compound is stevioside. In a preferred embodiment, stevioside comprises at least about 95% by weight of the first composition. In another embodiment, stevioside comprises at least about 96% by weight of the first composition. In another embodiment, stevioside comprises at least about 97% by weight of the first composition. In yet another embodiment, stevioside comprises at least about 98% by weight of the first composition. In still another embodiment, stevioside comprises at least about 99% by weight of the first composition. In another embodiment, stevioside is about 100% by weight of the first composition.

ii. The Second Composition

In one embodiment, the second compound is steviolmonocide. In a preferred embodiment, steviolmonocide comprises at least about 95% by weight of the second composition. In another embodiment, steviolmonocide comprises at least about 97% by weight of the second composition. In yet another embodiment, steviolmonoside comprises at least about 98% by weight of the second composition. In still another embodiment, steviolmonocide comprises at least about 99% by weight of the second composition. In another embodiment, steviolmonoside is about 100% by weight of the second composition.

In one embodiment, the second compound is steviolbiocide. In a preferred embodiment, steviolbioside comprises at least about 95% by weight of the second composition. In still another embodiment, steviolbioside comprises at least about 97% by weight of the second composition. In yet another embodiment, steviolbiocide comprises at least about 98% by weight of the second composition. In still another embodiment, steviolbiocide comprises at least about 99% by weight of the second composition. In another embodiment, steviolbiocide comprises about 100% by weight of the second composition.

In one embodiment, the second compound is rebaudioside B. In a preferred embodiment, rebaudioside B comprises at least about 95% by weight of the second composition. In another embodiment, rebaudioside B comprises at least about 97% by weight of the second composition. In yet another embodiment, rebaudioside B comprises at least about 98% by weight of the second composition. In still another embodiment, rebaudioside B comprises at least about 99% by weight of the second composition. In another embodiment, rebaudioside B is about 100% by weight of the second composition.

In some embodiments, the second composition comprises a mixture of compounds selected from the group consisting of steviolmonoside, steviolbioside and rebaudioside B. In a preferred embodiment, the mixture of second compounds comprises at least about 95% by weight of the second composition. In another embodiment, the mixture of second compounds comprises at least about 97% by weight of the second composition. In yet another embodiment, the mixture of second compounds comprises at least about 98% by weight of the second composition. In still another embodiment, the mixture of second compounds comprises at least about 99% by weight of the second composition. In another embodiment, the mixture of second compounds is about 100% by weight of the second composition.

In some embodiments, the first composition comprises the first compound rebaudioside A and the second composition comprises the second compound rebaudioside B. In other embodiments, the first composition comprises the first compound rebaudioside A and the second composition comprises the second compound steviolmonoside. In other embodiments, the first composition comprises the first compound rebaudioside A and the second composition comprises the second compound steviolbioside.

In some embodiments, the first composition comprises the first compound stevioside and the second composition comprises the second compound rebaudioside B. In other embodiments, the first composition comprises the first compound stevioside and the second composition comprises the second compound steviolmonoside. In other embodiments, the first composition comprises the first compound stevioside and the second composition comprises the second compound steviolbioside.

In some embodiments, the first composition comprises the first compound mogroside IV and the second composition comprises the second compound rebaudioside B. In other embodiments, the first composition comprises the first compound mogroside IV and the second composition comprises the second compound steviolmonoside. In other embodiments, the first composition comprises the first compound mogroside IV and the second composition comprises the second compound steviolbioside.

In some embodiments, the first composition comprises the first compound mogroside V and the second composition comprises the second compound rebaudioside B. In other embodiments, the first composition comprises the first compound mogroside V and the second composition comprises the second compound steviolmonoside. In other embodiments, the first composition comprises the first compound mogroside V and the second composition comprises the second compound steviolbioside.

In some embodiments, the first composition comprises the first compound mogroside VI and the second composition comprises the second compound rebaudioside B. In other embodiments, the first composition comprises the first compound mogroside VI and the second composition comprises the second compound steviolmonoside. In other embodiments, the first composition comprises the first compound mogroside VI and the second composition comprises the second compound steviolbioside.

In some embodiments, the first composition comprises the first compound isomogroside V and the second composition comprises the second compound rebaudioside B. In other embodiments, the first composition comprises the first compound isomogroside V and the second composition comprises the second compound steviolmonoside. In other embodiments, the first composition comprises the first compound isomogroside V and the second composition comprises the second compound steviolbioside.

In some embodiments, the first composition comprises the first compound 11-oxomogroside and the second composition comprises the second compound rebaudioside B. In other embodiments, the first composition comprises the first compound II-oxomogroside and the second composition comprises the second compound steviolmonoside. In other embodiments, the first composition comprises the first compound II-oxomogroside and the second composition comprises the second compound steviolbioside.

The ratio of the first composition to second composition controls the resultant flavor profile and/or temporal profile of the natural sweetener blend. In a preferred embodiment, the first composition comprises a majority of the natural sweetener blend. In one embodiment, the weight ratio of the first composition to the second composition is from about 99:1 to about 75:25. In another embodiment, the weight ratio of the first composition to the second composition is from about 95:5 to about 80:20. In yet another embodiment, the weight ratio of the first composition to the second composition is from about 92:8 to about 80:20. In still another embodiment, the weight ratio of the first composition to the second composition is from about 90:10 to 80:20. In certain embodiments, the weight ratio of the first composition to the second composition is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 84:16, about 83:17, about 82:18, about 81:19, about 80:20, about 79:21, about 78:22, about 77:23, about 76:24, about 75:25.

In a preferred embodiment, the weight ratio of the first composition to the second composition is about 83:17.

In one embodiment, the natural sweetener blend comprises:
(3) a first composition comprising at least about 95% rebaudioside A by weight, and
(4) a second composition comprising at least about 95% rebaudioside B by weight,
   wherein the weight ratio of the first composition to the second composition is from about 99:1 to about 75:25.

In a more preferred embodiment, the weight ratio of the first composition to the second composition is about 83:17.

In some embodiments, the Stevia blend comprises:
(1) a first compound selected from the group consisting of rebaudioside A and stevioside; and
(2) a second compound selected from the group consisting of steviolmonoside, steviolbioside, rebaudioside B and combinations thereof,
   wherein both the first and second compounds are about 100% pure, and
   wherein the weight ratio of the first compound to the second compound is from about 99:1 to about 75:25.

In a preferred embodiment, the natural sweetener blend consists of rebaudioside A as the first compound and rebaudioside B as the second compound, wherein the weight ratio of rebaudioside A to rebaudioside B is from about 99:1 to about 75:25, more preferably from about 92:8 to about 80:20, more preferably from about 80:20 to about 90:10. In certain embodiments, the weight ratio of rebaudioside A to rebaudioside B is about 92:9, more preferably about 85:15, more preferably about 83:17.

iii. Additional Ingredients

In some embodiments, the natural sweetener blends further comprise one or more additional sweeteners. The additional sweetener can be any type of sweetener, for example a natural, non-natural, or synthetic sweetener. In at least one embodiment, the at least one additional sweetener is chosen from natural sweeteners other than Stevia sweeteners or Lo Han Guo sweeteners. In another embodiment, the at least one additional sweetener is chosen from synthetic high potency sweeteners.

For example, the at least one additional sweetener may be a caloric carbohydrate sweetener. Non-limiting examples of suitable caloric carbohydrate sweeteners include sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, isomerized liquid sugars such as high fructose corn/starch syrup (HFCS/HFSS) (e.g., HFCS55, HFCS42, or HFCS90), coupling sugars, soybean oligosaccharides, glucose syrup, and mixtures thereof.

In other embodiments, the at least one additional sweetener is a natural sweetener selected from the group consisting of glucose, fructose, sucrose, and mixtures thereof.

In other embodiments, the at least one additional sweetener is a carbohydrate sweetener.

In yet other embodiments, the at least one additional sweetener is a synthetic sweetener. As used herein, the phrase “synthetic sweetener” refers to any composition which is not found naturally in nature and characteristically has a sweetness potency greater than sucrose, fructose, or glucose, yet has less calories. Non-limiting examples of synthetic high-potency sweeteners suitable for embodiments of this disclosure include sucralose, potassium acesulfame, aspartame, alitame, saccharin, neohesperidin dihydrochalcone, cyclamate, neotame, advantame, glucosylated steviol glycosides (GSGs), salts thereof, and the like.

In addition, those of ordinary skill in the art will appreciate that the natural sweetener blend, or sweetened composition comprising the natural sweetener blend, can be customized to obtain a desired calorie content. For example, a low-caloric or non-caloric synthetic sweetener may be combined with a caloric sweetener and/or other caloric additives to produce a natural sweetener blend, or a sweetened composition comprising a natural sweetener blend, with a preferred calorie content.

The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group.

Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the synthetic sweetener, the natural sweetener blend or sweetened compositions comprising the natural sweetener blend.

In some embodiments, the natural sweetener blends or sweetened compositions comprising natural sweetener blends also comprise at least one additional additive, such as a sweet taste improving composition, and/or a sweet taste improving additive.

For example, suitable sweet-taste improving compositions include, but are not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, flavonoids, alcohols, polymers, other sweet taste improving taste additives imparting such sugar-like taste quality, and combinations thereof.

As used herein, the phrase “sweet taste improving additive” means any material that imparts a more sugar-like temporal profile, sugar-like taste quality, sugar-like sweet temporal profile, sugar-like flavor profile or any combination thereof to a synthetic sweetener. Suitable sweet taste improving additives useful in embodiments of this disclosure include amino acids and salts thereof, poly-amino acids and salts thereof, peptides, sugar acids and salts thereof, nucleotides and salts thereof, organic acids, inorganic acids, organic salts including organic acid salts and organic base salts, inorganic acid salts (e.g., sodium chloride, potassium chloride, magnesium chloride), acid salts (e.g., sodium citrate), bitter compounds, flavorants and flavoring ingredients, astringent compounds, polymers, proteins or protein hydrolysates, surfactants, emulsifiers, flavonoids, alcohols, and natural high-potency sweeteners.

Suitable sweet taste improving amino acid additives for use in embodiments of this disclosure include, but are not limited to, aspartic acid, arginine, glycine, glutamic acid, proline, threonine, theanine, cysteine, cystine, alanine, valine, tyrosine, leucine, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The sweet taste improving amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable sweet taste improving additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable sweet taste improving polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The sweet taste improving poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable sweet taste improving additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sweet taste improving sugar acid additives include, for example, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

For example, suitable sweet taste improving nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable sweet taste improving organic acid additives include any compound which comprises a —COOH moiety. Suitable sweet taste improving organic acid additives, for example, include but are not limited to C2-C30 carboxylic acids, substituted hydroxyl C2-C30 carboxylic acids, benzoic acid, substituted benzoic acids (e.g., 2,4-dihydroxybenzoic acid), substituted cinnamic acids, hydroxyacids, substituted hydroxybenzoic acids, substituted cyclohexyl carboxylic acids, tannic acid, lactic acid, tartaric acid, citric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

For example, suitable sweet taste improving organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), and adipic acid. The examples of the sweet taste improving organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phospho, phosphonato, and any other viable functional group provided the substituted organic acid additives function to improve the sweet taste of a synthetic sweetener.

For example, suitable sweet taste improving inorganic acid additives include but are not limited to phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

B. Sweetened Compositions

In one embodiment, a sweetened composition of the present invention comprises a natural sweetener blend comprising:
(1) a first composition comprising at least one first compound selected from the group consisting of mogroside IV, mogroside V, mogroside VI, isomogroside V, 11-oxomogroside, rebaudioside A, stevioside and combinations thereof,
   wherein the at least one first compound is present in an amount of at least about 95% by weight of the first composition; and
(2) a second composition comprising at least one second compound selected from the group consisting of steviolmonoside, steviolbioside, rebaudioside B and combinations thereof,
   wherein the at least one second compound is present in an amount of at least about 95% by weight of the second composition; and
   wherein the ratio of the first composition to the second composition is from about 99:1 to about 75:25.

In preferred embodiments, the sweetened compositions comprise a sweetenable composition. As used herein, “orally ingestible composition” and “sweetenable composition” are synonymous and mean substances which are contacted with the mouth of man or animal, including substances which are taken into and subsequently ejected from the mouth and substances which are drunk, eaten, swallowed or otherwise ingested, and are safe for human or animal consumption when used in a generally acceptable range. These compositions include, for example, food, beverage, pharmaceutical, tobacco, nutraceutical, oral hygienic/cosmetic products, and the like. Non-limiting examples of these products include non-carbonated and carbonated beverages such as colas, ginger ales, root beers, ciders, fruit-flavored soft drinks (e.g., citrus-flavored soft drinks such as lemon-lime or orange), powdered soft drinks, and the like; fruit juices originating in fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables; sport drinks, energy drinks, near water and the like drinks (e.g., water with natural or synthetic flavorants); tea type or favorite type beverages such as coffee, cocoa, black tea, green tea, oolong tea and the like; beverages containing milk components such as milk beverages, coffee containing milk components, cafe au lait, milk tea, fruit milk beverages, drinkable yogurt, lactic acid bacteria beverages or the like; dairy products; bakery products; desserts such as yogurt, jellies, drinkable jellies, puddings, Bavarian cream, blancmange, cakes, brownies, mousse and the like, sweetened food products eaten at tea time or following meals; frozen foods; cold confections, e.g. types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); ice cream; general confections, e.g., baked confections or steamed confections such as cakes, crackers, biscuits, buns with bean-jam filling and the like; rice cakes and snacks; table top products; general sugar confections such as chewing gum (e.g., including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans and the like; sauces including fruit flavored sauces, chocolate sauces and the like; edible gels; cremes including butter cremes, flour pastes, whipped cream and the like; jams including strawberry jam, marmalade and the like; breads including sweet breads and the like or other starch products; spice; general condiments including seasoned soy sauce used on roasted meats, roast fowl, barbecued meat and the like, as well as tomato catsup, sauces, noodle broth and the like; processed agricultural products, livestock products or seafood; processed meat products such as sausage and the like; retort food products, pickles, preserves boiled in soy sauce, delicacies, side dishes; snacks such as potato chips, cookies, or the like; cereal products; drugs or quasi-drugs that are administered orally or used in the oral cavity (e.g., vitamins, cough syrups, cough drops, chewable medicine tablets, amino acids, bitter-tasting drug or pharmaceutical agents, acidulants or the like), wherein the drug may be in solid, liquid, gel, or gas form such as a pill, tablet, spray, capsule, syrup, drop, troche agent, powder, and the like; personal care products such as other oral compositions used in the oral cavity such as mouth freshening agents, gargling agents, mouth rinsing agents, toothpaste, tooth polish, dentifrices, mouth sprays, teeth-whitening agents and the like; dietary supplements; tobacco products including smoke and smokeless tobacco products such as snuff, cigarette, pipe and cigar tobacco, and all forms of tobacco such as shredded filler, leaf, stem, stalk, homogenized leaf cured, reconstituted binders and reconstituted tobacco from tobacco dust, fines or ether sources in sheet, pellet or other forms, tobacco substitutes formulated from non-tobacco materials, dip or chewing tobacco; animal feed; and nutraceutical products, which includes any food or part of a food that may provide medicinal or health benefits, including the prevention and treatment of disease (e.g., cardiovascular disease and high levels of cholesterol in the blood, diabetes, osteoporosis, inflammation, or autoimmune disorders).

In a preferred embodiment, the sweetenable composition is a liquid matrix. Liquid matrices include, but are not limited to, water, phosphoric acid, phosphate buffer, citric acid, citrate buffer, carbon-treated water and combinations thereof.

In a preferred embodiment, the sweetened composition is a beverage. In one embodiment, the sweetened composition is a reduced calorie beverage comprising a natural sweetener blend and a caloric sweetener. The term “reduced calorie,” as generally used herein, refers to a sweetened composition comprising a natural sweetener blend of the present invention in combination with a caloric sweetener. Incorporating the natural sweetener blend, which is non-caloric, decreases the caloric content of a comparable sweetened composition containing only the caloric sweetener.

In a preferred embodiment, a reduced calorie beverage comprises a caloric sweetener and a natural sweetener blend. The caloric sweetener can be selected from the group consisting of sucrose, fructose, glucose, high fructose corn syrup (HFCS), high fructose starch-based syrup (HFSS) or a combination thereof. The reduce calorie beverage preferably comprises a natural sweetener blend comprising a first composition comprising the first compound rebaudioside A, a second composition comprising the second compound rebaudioside B, and a caloric sweetener selected from the group consisting of sucrose, fructose, glucose, high fructose corn syrup (HFCS), high fructose starch-based syrup (HFSS) or a combination thereof. The reduced calorie beverage can further comprise glucosylated steviol glycosides (GSGs). The term “glucosylated steviol glycosides,” as used herein, refers to synthetic sweeteners that are obtained by enzymatic glucosylation of Stevia extract or compounds isolated from Stevia extract.

In another embodiment, the sweetened composition is a zero-calorie beverage. Zero-calorie beverages of the present invention comprise a natural sweetener blend of the present invention and erythritol. In a preferred embodiment, a zero-calorie beverage comprises erythritol and a natural sweetener blend comprising a first composition comprising the first compound rebaudioside A and a second composition comprising a second compound rebaudioside B. The zero-calorie beverage can further comprise glucosylated steviol glycosides.

C. Methods for Improving Sugar-Like Taste Quality

In preferred embodiments, the natural sweetener blends described herein exhibit improved sugar-like taste quality compared to sweetener compositions of either the first composition or second composition alone. Accordingly, some aspects of the present invention include a method for improving the sugar-like taste quality of a sweetened composition, comprising combining:
(1) a sweetenable composition; and
(2) a first composition comprising at least one first compound selected from the group consisting of mogroside IV, mogroside V, mogroside VI, isomogroside V, 11-oxomogroside, rebaudioside A, stevioside and combinations thereof,
   wherein the at least one first compound is present in an amount of at least about 95% by weight of the first composition; and
(3) a second composition comprising at least one second compound selected from the group consisting of steviolmonoside, steviolbioside, rebaudioside B and combinations thereof,
   wherein the at least one second compound is present in an amount of at least about 95% by weight of the second composition; and
   wherein the ratio of the first composition to the second composition is from about 99:1 to about 75:25.

An improved sugar-like taste quality can be determined by comparing the flavor profile and/or temporal profile of the natural sweetener blend to the flavor profile and/or temporal profile of the first composition or the second composition. Alternatively, the improved sugar-like taste quality can be determined by comparing the flavor and/or temporal profile of the natural sweetener blend to either the first compound or the second compound. Typically this comparison is performed in a sweetened composition, which is made of a sweetenable composition (for example, water, acidic, buffer, etc.) and the natural sweetener blend.

In some embodiments, the sweetness intensity of the natural sweetener blends, or sweetened compositions comprising the natural sweetener blends, increases by greater than 0.5%, such as 1%, 2%, 3%, 4% or 5%, relative to the sweetness of either the first composition or second composition separately, as measured by sucrose equivalence. For example, the sweetness intensity of a sweetened composition comprising a natural sweetener blend may increase by greater than 10%, or by greater than 20%, relative to the sweetness of a sweetened composition comprising the first composition, as measured by sucrose equivalence.

In other embodiments, the bitterness of the natural sweetener blends, or sweetened compositions comprising the natural sweetener blends, is decreased relative to the first composition, the second composition or sweetened compositions comprising the first or second compositions.

In other embodiments, the detected licorice taste of the natural sweetener blends, or sweetened compositions comprising the natural sweetener blends, is decreased relative to the first composition, the second composition or sweetened compositions comprising the first or second compositions.

In other embodiments, the sweetness linger (aftertaste) of the natural sweetener blends, or sweetened compositions comprising the natural sweetener blends, is decreased relative to the first composition, the second composition or sweetened compositions comprising the first or second compositions.

In preferred embodiments, one or more attributes of the sugar-like taste quality of the natural sweetener blends or sweetened compositions comprising the natural sweetener blends is improved relative to the first composition, the second composition or sweetened compositions comprising the first or second compositions. For example, the bitterness, licorice taste and sweetness linger can all be simultaneously decreased in the natural sweetener blends, or sweetened compositions comprising the natural sweetener blends, relative to the first composition, the second composition or sweetened compositions comprising the first or second compositions.

It is contemplated that the combination of the first composition and the second composition may be carried out in any pH range that does not materially or adversely affect the taste of the natural sweetener blend or the sweetened composition comprising the natural sweetener blend. A non-limiting example of the pH range may be from about 1.8 to about 8. A further example includes a pH range from about 2 to about 5. The temperature of the composition may, for example, range from 4° C. to 25° C.

The natural sweetener compositions described herein can be combined with any liquid matrix (a type of sweetenable composition) to formed a liquid sweetened composition. Liquid matrices include, but are not limited to water, phosphoric acid, phosphate buffer, citric acid, citrate buffer and carbon-treated water.

### EXAMPLES

### Example 1

### Taste Test of Rebaudioside A

Multi-Sip and Swallow Test Method

A sip (approximately 2.0-5.0 mL) of a sample was swallowed by a trained taste tester. After allowing a 15-25 second interval to pass, a second sip of the sample is tasted and swallowed. This process is repeated as needed to determine the taste properties. The taste properties are then recorded by the trained taste tester. Preferably no more than ten samples are tested per day to avoid taste fatigue. Each sample was taken at least 1.5 hours following eating or drinking.

A sample of 500 ppm rebaudioside A in carbon-treated water was tasted according to the multi-sip and swallow method described above. The sample had a sweetness intensity of 5 out of 10 (sweet), a bitterness intensity of 4 out of 5 (significant bitterness), sugar-like tasting quality of 0 out of 5 (none) and a sweetness linger of 5 out of 5 (very high).

A sample of 100,000 ppm sugar in carbon-treated water was tasted according to the multi-sip and swallow method described above. The sample had a sweetness intensity of 10 (sweet), a bitterness intensity of 0 (none), a sugar-like tasting quality of 5 (very high) and a sweetness linger of 0 (none).

A sample of 500 ppm stevioside in carbon-treated water was tasted according to the multi-sip and swallow method described above. The sample had a sweetness intensity of 5 out of 10 (sweet), a bitterness intensity of 5 out of 5 (significant bitterness), sugar-like tasting quality of 0 out of 5 (none) and a sweetness linger of 5 out of 5 (very high).

### Example 2

### Taste Test of Rebaudioside B

A sample of 500 ppm rebaudioside B in carbon-treated water was tasted according to the multi-sip and swallow method described above. The sample had a sweetness intensity of 2 and exhibited significant sugar-like tasting quality (3) and a bitterness intensity (O). The sweetness linger of the sample was 3 (moderate).

### Example 3

### Taste Test of Steviolbioside

A sample of 500 ppm steviolbioside in carbon-treated water was tasted according to the multi-sip and swallow method described above. The sample had a sweetness intensity of 5 and exhibited sugar-like tasting quality of 2 and no bitterness. The sample had a slow sweetness onset and a sweetness linger of 3.

### Example 4

### Taste Test of Rebaudioside A: Rebaudioside B Blends

Four sweetener compositions containing various ratios of rebaudioside A and rebaudioside B in carbon-treated water were evaluated using the multi-sip and swallow method described above. The results are shown in Table 1:

TABLE 1

| Rebaudioside A: | | | | |
|---|---|---|---|---|
| Rebaudioside B | | | Sugar-Like | Sweetness |
| (wt %:wt %) | Sweetness | Bitterness | Taste Quality | Linger |
| 75:25 | 3.5 | 0 | 4 | 2 |
| | Hollow-like | | Moderate | |
| | sweetness | | | |
| | temporal | | | |
| | profile; Less | | | |
| | sweet than | | | |
| | rebaudioside | | | |
| | A control | | | |
| 50:50 | 2.5 | 1 | 4 | 3 |
| | Less sweet | Slight | Moderate | |
| | than | amount | | |
| | rebaudioside | detected | | |
| | A control | | | |
| 25:75 | 2 | 0 | 5 | 2 |
| | Strong | | Strong | |
| | hollow-like | | | |
| | sweetness | | | |
| | temporal | | | |
| | profile | | | |
| 83:17 | 5 | 0 | 5 Significant | 2 |
| | | | | Decreased |
| | | | | sweetness |
| | | | | linger |
| | | | | compared to |
| | | | | rebaudioside |
| | | | | A control |

Notably, the 83:17 rebaudioside A: rebaudioside B blend had a more sugar-like tasting quality with no detectable bitterness or licorice tastes.

### Example 5

### Taste Test of Rebaudioside A: Steviolbioside Blends

Two sweetener compositions containing various ratios of rebaudioside A and steviolbioside in carbon-treated water were evaluated using the multi-sip and swallow method described above. The results are shown in Table 2:

TABLE 2

| Rebaudioside A: | | | | |
|---|---|---|---|---|
| Steviolbioside | | | Sugar-Like | Sweetness |
| (wt %:wt %) | Sweetness | Bitterness | Taste Quality | Linger |
| 75:25 | 4 | 1 | 1.5 | 2 |
| | Slightly less | Minimal | Slight | |
| | sweet than | detected | | |
| | rebaudioside A | | | |
| 50:50 | 2 | 0 | 3.5 | 2 |
| | Minimal | | Tasted like | |
| | | | steviolbioside | |
| | | | control | |

### Example 6

### Taste Test of Rebaudioside A: Rebaudioside B: Steviolbioside Blends

Two sweetener compositions containing various ratios of rebaudioside A, rebaudioside B and steviolbioside in carbon-treated water were evaluated using the multi-sip and swallow method described above. The results are shown in Table 3:

TABLE 3

| Rebaudioside A: | | | | |
|---|---|---|---|---|
| Rebaudioside B: | | | Sugar-Like | Sweet- |
| Steviolbioside | | | Taste | ness |
| (wt %:wt %:wt %) | Sweetness | Bitterness | Quality | Linger |
| 78:11:11 | 5 | 2 | 1 | 5 |
| | | Minimal detected | | |
| 74:14:14 | 4 | 2 | 2 | 3.5 |
| | | Minimal detected | | |

### Discussion

Although rebaudioside A is known to be one of the sweetest steviol glycosides, the compound actually exhibits a number of negative taste properties. The compound is characterized by bitterness, a licorice taste, and a sweetness linger of 5 (very high) when used in the concentrations necessary to obtain 10% sucrose equivalence, a common metric used to measure the flavor and temporal profile of a sweetener. Rebaudioside B is less sweet than rebaudioside A, has a sweetness linger of 3 (moderate). However, surprisingly, when rebaudioside A and rebaudioside B are combined in certain ratios, particularly 83:17 (rebaudioside A: rebaudioside B), the blend exhibits superior taste properties compared to either component separately. The blend exhibits minimal bitterness, more sugar-like tasting quality. In addition, the sweetness linger of the blend is significantly decreased compared to rebaudioside A (less than 3 out of highest five), and has an overall sugar-like taste quality (i.e. sucrose-like in flavor and temporal profile) than is a significant improvement over the flavor and temporal profile of either rebaudioside A or rebaudioside B separately.

Rebaudioside D is considered the sweetest among the steviol glycosides that can be obtained from the Stevia. However, it comprises less than 1% of the steviol glycosides from the Stevia plant. Although the compound is sweet, rebaudioside D exhibits less sweetness and slightly more sugar-like taste quality than that of rebaudioside A as it has a high sweetness linger (5). The 83:17 rebaudioside A: rebaudioside B blend described herein exhibits superior taste properties compared to rebaudioside D.

What is claimed is:

1. A natural sweetener blend comprising:
(1) a first composition comprising at least one first compound selected from the group consisting of mogroside IV, mogroside V, mogroside VI, isomogroside V, 11-oxomogroside, rebaudioside A, stevioside and combinations thereof,
wherein the at least one first compound is present in an amount of at least about 95% by weight of the first composition; and
(2) a second composition comprising at least one second compound selected from the group consisting of steviolmonoside, steviolbioside, rebaudioside B and combinations thereof,
wherein the at least one second compound is present in an amount of at least about 95% by weight of the second composition; and
wherein the weight ratio of the first composition to the second composition is from about 99:1 to about 75:25.

2. The natural sweetener blend of claim 1, wherein the at least one first compound is rebaudioside A.

3. The natural sweetener blend of claim 2, wherein rebaudioside A is present in an amount of at least about 97% by weight of the first composition.

4. The natural sweetener blend of claim 2, wherein rebaudioside A is about 100% by weight of the first composition.

5. The natural sweetener blend of claim 1, wherein the at least one first compound is stevioside.

6. The natural sweetener blend of claim 5, wherein stevioside is present in an amount of at least about 97% by weight of the first composition.

7. The natural sweetener blend of claim 5, wherein stevioside is about 100% by weight of the first composition.

8. The natural sweetener blend of claim 1, wherein steviolmonoside is the second compound.

9. The natural sweetener blend of claim 8, wherein steviolmonoside is present in an amount of at least about 97% by weight of the second composition.

10. The natural sweetener blend of claim 8, wherein steviolmonoside is about 100% by weight of the second composition.

11. The natural sweetener blend of claim 1, wherein steviolbioside is the second compound.

12. The natural sweetener blend of claim 11, wherein steviolbioside is present in an amount of at least about 97% by weight of the second composition.

13. The natural sweetener blend of claim 11, wherein steviolbioside is about 100% by weight of the second composition.

14. The natural sweetener blend of claim 1, wherein rebaudioside B is the second compound.

15. The natural sweetener blend of claim 14, wherein rebaudioside B is present in an amount of at least about 97% by weight of the second composition.

16. The natural sweetener blend of claim 14, wherein rebaudioside B is about 100% by weight of the second composition.

17. The natural sweetener blend of claim 1, wherein the first composition comprises rebaudioside A and the second composition comprises rebaudioside B, and
wherein the ratio of the first composition to the second composition is about 83:17.

18. A natural sweetener blend consisting of:
(1) a first compound selected from the group consisting of rebaudioside A and stevioside; and
(2) a second compound selected from the group consisting of steviolmonoside, steviolbioside and rebaudioside B,
wherein both the first and second compound are about 100% pure, and
wherein the weight ratio of the first compound to the second compound is from about 99:1 to about 75:25.

19. A beverage comprising:
(1) a first composition comprising at least about 95% rebaudioside A by weight, and
(2) a second composition comprising at least about 95% rebaudioside B by weight,
wherein the weight ratio of the first composition to the second composition is from about 99:1 and about 75:25.

20. The beverage of claim 19, wherein the beverage is a reduced calorie beverage further comprising a caloric sweetener selected from the group consisting of sucrose, fructose, glucose, high fructose corn syrup (HFCS), high fructose starch-based syrup (HFSS) or a combination thereof.

21. The beverage of claim 19, wherein the sweetened composition is a zero-calorie beverage further comprising erythritol.

22. A sweetened composition comprising a sweetenable composition and a natural sweetener blend of any of claims 1-18.

23. A method for a method for improving the sugar-like taste quality of a sweetened composition, comprising combining:
(1) a sweetenable composition;
(2) a first composition comprising at least one first compound selected from the group consisting of mogroside IV, mogroside V, mogroside VI, isomogroside V, 11-oxomogroside, rebaudioside A and stevioside,
wherein the at least one first compound is present in an amount of at least about 95% by weight of the first composition; and
(3) a second composition comprising at least one second compound selected from the group consisting of steviolmonoside, steviolbioside, rebaudioside B and combinations thereof,
wherein the at least one second compound is present in an amount of at least about 95% by weight of the second composition; and
wherein the ratio of the first composition to the second composition is from about 99:1 to about 75:25.
